(19) United States
(12) Patent Application Publication
(10) Pub. No.: US 2026/0368495 A1
(43) Pub. Date: Nov. 19, 2026

(54) GENERATIVE ARTIFICIAL INTELLIGENCE-BASED MIDDLEWARE FOR DATA SYNTHESIS

(71) Applicant: Dell Products L.P., Round Rock, TX (US)

(72) Inventors: Bijan Kumar Mohanty, Austin, TX (US); Dhilip S. Kumar, Bangalore (IN); Sujit Kumar Sahoo, Bangalore (IN); Hung T. Dinh, Austin, TX (US)

(21) Appl. No.: 19/207,939

(22) Filed: May 14, 2025

(51) Int. Cl. G06N 3/0475; G06N 3/094

(52) U.S. Cl. CPC G06N 3/0475; G06N 3/094

(57) ABSTRACT

Methods, apparatus, and processor-readable storage media for implementing generative artificial intelligence-based middleware for data synthesis are provided herein. An example computer-implemented method includes obtaining at least one request for data related to execution of at least one application; determining at least one of one or more required fields and one or more domain-specific constraints associated with the at least one request for data; generating, using one or more generative artificial intelligence techniques, synthetic data responsive to the at least one request and in accordance with one or more data obfuscation rules and the at least one of one or more required fields and one or more domain-specific constraints; and performing one or more automated actions using at least a portion of the synthetic data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In many contexts, demonstrations are commonly carried out in furtherance of showcasing software and/or hardware capabilities to various stakeholders and/or users. However, in such demonstrations, emphasis on data privacy, regulatory compliance, and/or information security presents significant challenges. Further, conventional demonstration approaches often result in data breaches, regulatory violations, and reputational damage.

### SUMMARY

Illustrative embodiments of the disclosure provide generative artificial intelligence-based middleware for data synthesis.

An example computer-implemented method includes obtaining at least one request for data related to execution of at least one application, and determining at least one of one or more required fields and one or more domain-specific constraints associated with the at least one request for data. Additionally, the method includes generating, using one or more generative artificial intelligence techniques, synthetic data responsive to the at least one request and in accordance with one or more data obfuscation rules and the at least one of one or more required fields and one or more domain-specific constraints. Further, the method also includes performing one or more automated actions using at least a portion of the synthetic data.

Illustrative embodiments can provide significant advantages relative to conventional demonstration approaches. For example, problems associated with data breaches, regulatory violations, and reputational damage are overcome in one or more embodiments through automatically generating synthetic data for use in one or more particular contexts through the implementation and use of generative artificial intelligence-based middleware.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing generative artificial intelligence-based middleware for data synthesis in an illustrative embodiment.

FIG. 2 shows an example system architecture and workflow in an illustrative embodiment.

FIG. 3 shows example pseudocode for determining constraints in an illustrative embodiment.

FIG. 4 shows example pseudocode for determining constraints in an illustrative embodiment.

FIG. 5 shows example pseudocode for determining constraints in an illustrative embodiment.

FIG. 6 shows example pseudocode for generating synthetic data from JavaScript object notation (JSON) input using at least one conditional tabular generative adversarial network (CTGAN) in an illustrative embodiment.

FIG. 7 shows example pseudocode for generating synthetic data from a comma-separated values (CSV) file using at least one CTGAN in an illustrative embodiment.

FIG. 8 shows example pseudocode for implementing at least one example usage endpoint in an illustrative embodiment.

FIG. 9 shows example pseudocode for implementing a synthetic data response in an illustrative embodiment.

FIG. 10 is a flow diagram of a process for implementing generative artificial intelligence-based middleware for data synthesis in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

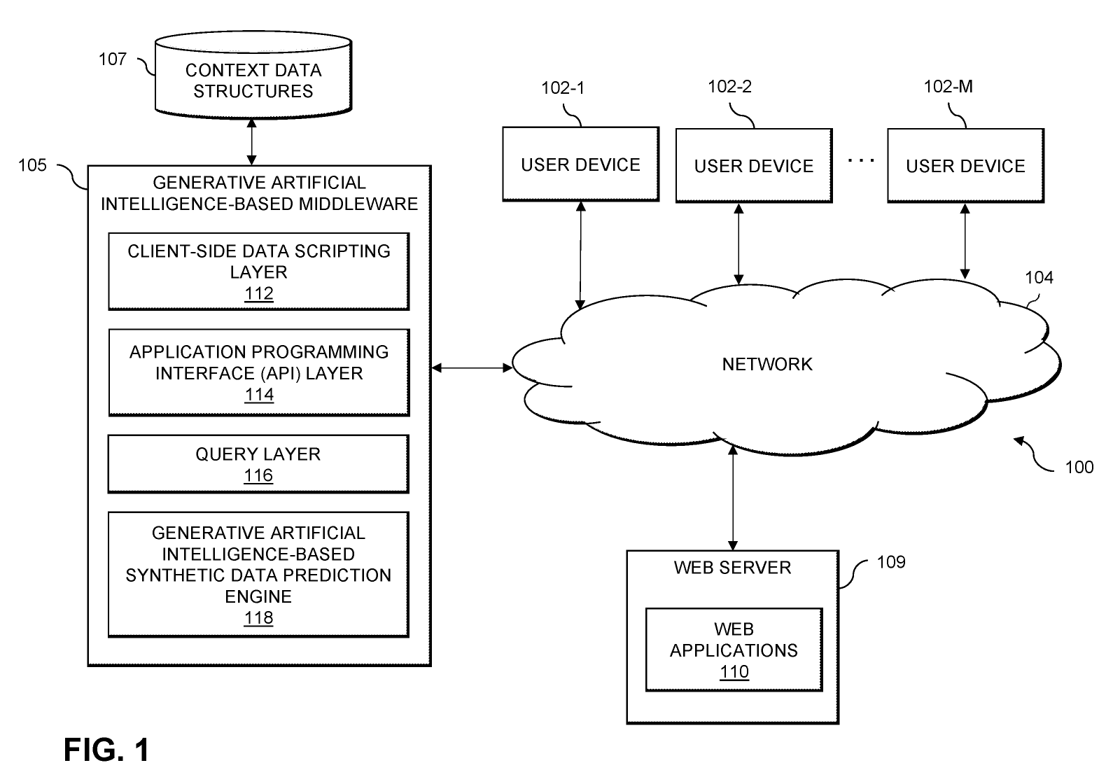

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is generative artificial intelligence-based middleware 105 and web server 109, upon which one or more web applications 110 execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the generative artificial intelligence-based middleware 105 can include and/or be associated with one or more context data structures 107 configured to store various context data and corresponding and/or related data policies (e.g., one or more data obfuscation policies). The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The context data structures 107 in the present embodiment are implemented using one or more storage systems associated with the generative artificial intelligence-based middleware 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the generative artificial intelligence-based middleware 105 are one or more input-output devices, which illustratively comprise keyboards, displays or other types of input-output devices in any combination. Such input-output devices can be used, for example, to support one or more user interfaces to the generative artificial intelligence-based middleware 105, as well as to support communication between the generative artificial intelligence-based middleware 105 and other related systems and devices not explicitly shown.

Additionally, the generative artificial intelligence-based middleware 105 in the FIG. 1 embodiment is assumed to be implemented using at least one processing device. Each such processing device generally comprises at least one processor and an associated memory, and implements one or more functional modules for controlling certain features of the generative artificial intelligence-based middleware 105.

More particularly, the generative artificial intelligence-based middleware 105 in this embodiment can be associated with and/or linked to a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the generative artificial intelligence-based middleware 105 to communicate over the network 104 with the user devices 102 and/or the web applications 110 executing on web server 109, and illustratively comprises one or more conventional transceivers.

The generative artificial intelligence-based middleware 105 further comprises a client-side data scripting layer 112, an application programming interface (API) layer 114, a query layer 116, and a generative artificial intelligence-based synthetic data prediction engine 118.

In at least one embodiment, the client-side data scripting layer 112 transforms and/or formats data based at least in part on client needs and/or preferences (e.g., processed in connection with user device 102), and the API layer 114 transforms data based at least in part on enterprise logic. Additionally, in such an embodiment, the query layer 116 fetches data from context data structures 107, and the generative artificial intelligence-based synthetic data prediction engine 118 generates synthetic data based at least in part on inputs from elements 112, 114 and/or 116.

It is to be appreciated that this particular arrangement of elements 112, 114, 116 and 118 illustrated in the generative artificial intelligence-based middleware 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for implementing generative artificial intelligence-based middleware for data synthesis involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of generative artificial intelligence-based middleware 105, user devices 102, context data structures 107, and web applications 110 can be on and/or part of the same processing platform.

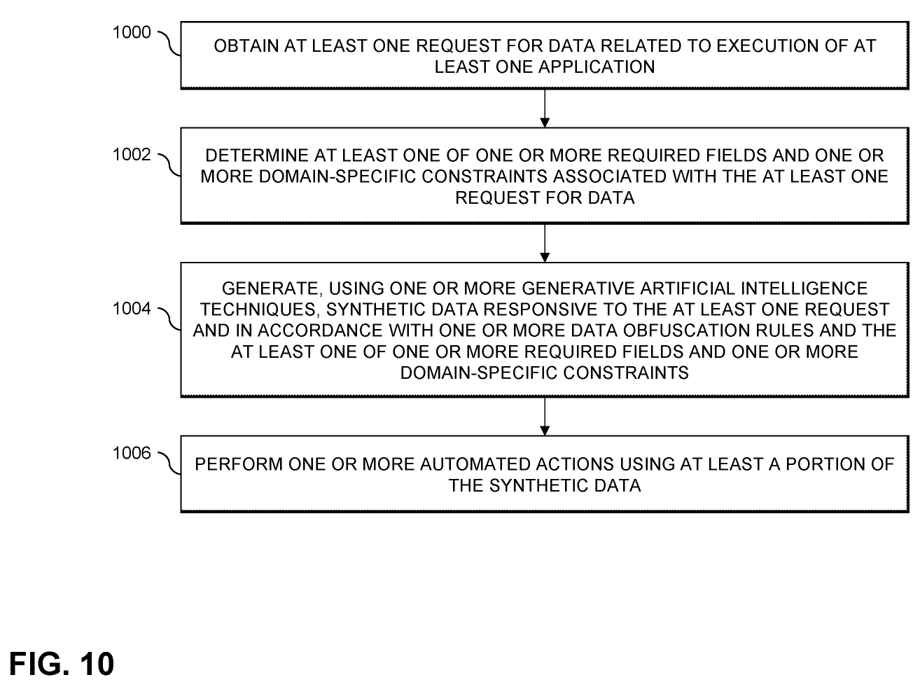

An example process utilizing elements 112, 114, 116 and 118 of an example generative artificial intelligence-based middleware 105 in computer network 100 will be described in more detail with reference to the flow diagram of FIG. 10.

Accordingly, at least one embodiment includes generative artificial intelligence-based middleware for data synthesis. As further detailed herein, such an embodiment includes leveraging one or more generative artificial intelligence models to dynamically generate structurally and contextually accurate synthetic datasets without persisting any real or generated data. By serving as an intelligent intermediary between one or more data sources and one or more demonstration applications, such an embodiment includes seamlessly intercepting and transforming requests, enabling privacy-compliant demonstrations without compromising the integrity of production environments.

One or more embodiments include stateless processing, ad hoc and/or dynamic data synthesis, implementation of configurable obfuscation rules, and integration with existing databases, APIs, and/or microservices. Such an embodiment includes facilitating compliance with various data protection regulations, while also maintaining authenticity and realism required for impactful demonstrations.

By reducing and/or eliminating reliance on manually masked datasets and/or outdated static data, at least one embodiment includes enhancing operational efficiency, strengthening user trust, and providing a scalable, domain-agnostic approach to privacy-preserving software demonstrations. Accordingly, as further detailed herein, such an embodiment includes generating and/or implementing an artificial intelligence-based dynamic data synthesis framework that enables systems and/or enterprises to conduct privacy-preserving product demonstrations without compromising data security and/or regulatory adherence. By leveraging generative artificial intelligence techniques and intelligent data obfuscation mechanisms, such an embodiment includes implementing a middleware solution which ensures that displayed data is dynamically generated, structurally accurate, and consistent from real-world information, all while maintaining a stateless, high-performance, and scalable architecture.

One or more embodiments includes inserting at least one generative artificial intelligence-based middleware between at least one data source (e.g., at least one data structure) and at least one demonstration application. Such a middleware is configured to intercept requests for data from the at least one demonstration application, and dynamically generate at least one synthetic dataset to be provided and/or used in response to the intercepted requests. Such dynamic synthetic data generation can be carried out approximately in real-time based at least in part on processing the corresponding request for data using one or more generative artificial intelligence models (e.g., one or more generative pretrained transformers (GPTs) and/or one or more domain-specific generative models) to produce synthetic but structurally consistent data.

In the context of synthetic data generation (e.g., in connection with using models such as CTGAN), structurally consistent data generally refers to synthetic data that preserves the schema, one or more relationships, and one or more constraints of the real or original data. With respect to schema consistency, the data types (e.g., string, integer, float, datetime, etc.) and column names in the synthetic data should match those in the original dataset. With respect to value constraints, the synthetic data should respect domain-specific rules and/or logical constraints associated with the use case and/or original dataset, and such rules and/or constraints can be enforced using tools such as, e.g., Positive() or ColumnFormula() from a synthetic data vault (SDV).

With respect to relational consistency, if the data spans multiple related tables (e.g., orders and customers), structural consistency ensures foreign keys and relationships are preserved. Also, with respect to format and pattern preservation, for format-specific columns such as, e.g., email columns and/or phone number columns, the format and structure should remain similar in the synthetic data. Additionally, in one or more embodiments, with respect to statistical similarity, a synthetic data generator can attempt to maintain the distribution and correlations between columns to render the synthetic data statistically realistic (e.g., high price often correlates with low discount).

In at least one embodiment, structural consistency is implemented and/or emphasized in the generation of synthetic data for a number of reasons. For example, one or more downstream applications may expect data in a specific structure to facilitate data validation and schema enforcement. Additionally, structural consistency can facilitate avoiding data breaking bugs, wherein poorly structured synthetic data can potentially break pipelines and/or lead to misleading results. Further, for example, structurally consistent synthetic data can lead to realistic simulations, such as testing models and/or software systems as if operating on production data.

Further, in at least one embodiment, dynamically generated synthetic data is not permanently stored but can be discarded after being used by at least one front-end system (e.g., a demonstration application). Also, such an embodiment can include connecting with one or more existing data structures, one or more application programming interfaces (APIs), and/or one or more microservices through one or more protocols (e.g., representational state transfer (REST), GraphQL, one or more message queues, etc.). Additionally, at least one embodiment includes implementing one or more configurable masking rules which can, for example, enable and/or facilitate role-based and/or attribute-level data transformation to cater to one or more domain-specific needs.

As further detailed herein, architectural components of one or more embodiments can include at least one data access layer, at least one generative artificial intelligence engine, at least one data obfuscation rules engine, at least one runtime execution layer, at least one stateless output generator, and/or at least one API gateway. In such an embodiment, the at least one data access layer is configured to intercept data requests to one or more data sources (containing real data) and/or services, and to process and/or parse one or more parameters from the requests to determine and/or understand the corresponding data schema and/or data attributes needed. As used herein, data schema generally refers to a blueprint for what valid data looks like, and preserving the data schema during synthetic data generation can ensure structural consistency and usability.

Also, in such an embodiment, the at least one generative artificial intelligence engine is configured to receive request structure information from the data access layer, and utilize relevant generative artificial intelligence models to produce synthetic data conforming to the data schema and request structure information. Further, the at least one generative artificial intelligence engine can be configured to apply one or more domain constraints (e.g., date ranges, numeric bounds, specific identifier (ID) formats, etc.) to the generated synthetic data.

Additionally, the at least one data obfuscation rules engine can be configured to contain and/or maintain enterprise rules, compliance requirements, and/or user-defined patterns, and leverage such information to replace and/or obfuscate any relevant and/or sensitive fields in the generated synthetic data. In at least one embodiment, the at least one data obfuscation rules engine can perform actions such as, for example, enforce regulatory guidelines and/or internal enterprise data policies, and apply one or more field-level rules (e.g., hash emails but pseudonymize names, maintain referential integrity where needed (such as, e.g., keeping user relationships consistent across tables), etc. Also, one or more embodiments can include integrating the at least one data obfuscation rules engine with one or more data classification and/or data tagging systems to automatically identify such sensitive fields in the generated synthetic data.

In at least one embodiment, the at least one runtime execution layer is configured to coordinate request and response flows between the given demonstration application, the at least one data access layer, and the at least one generative artificial intelligence engine. Also, the at least one runtime execution layer can be configured to apply and/or integrate one or more performance optimizations (e.g., caching templates for faster generation, maintaining minimal session-based context, etc.) into the framework.

Further, in one or more embodiments, the at least one stateless output generator is configured to transmit the synthetic data, subsequent to generation by the at least one generative artificial intelligence engine and processing (e.g., obfuscation) by the at least one data obfuscation rules engine, to the demonstration application and/or display environment. No data, real or synthetic, is stored in permanent storage. Rather, in such an embodiment, the data is discarded subsequent to use by the demonstration application.

When applied to synthetic data generation and/or data obfuscation, one or more embodiments can include treating each data generation or data obfuscation request as isolated, as well as not persisting user data, sensitive inputs, and/or transformation history. Further, in such an embodiment, any necessary input (e.g., schema, constraints, obfuscation rules, etc.) must be provided with each request, which helps ensure privacy, security, scalability, and stateless deployment (e.g., serverless functions, REST APIs, etc.).

Additionally, at least one embodiment can also optionally include the at least one API gateway, which can be configured to provide at least one unified endpoint for applications to request data. In such an embodiment, the at least one API gateway can facilitate management of authentication techniques, rate limiting, load balancing, etc.

By way merely of illustration, consider the following example process flow implementing one or more embodiments. Initially, a user triggers a demonstration scenario in a given front-end application and requests data to be used in the demonstration. This request is then intercepted and/or processed by a data access layer (instead of an existing database and/or data structure), and the data access layer performs schema analysis by parsing the request and identifying one or more required fields (e.g., user name, transaction amount, etc.). The one or more required fields are passed to a generative artificial intelligence engine, and based at least in part on the schema and one or more data obfuscation rules (e.g., implemented in connection with a data obfuscation rules engine), synthetic data is generated by the generative artificial intelligence engine. Further, at least a portion of the generated synthetic data is returned to the front-end application for display (e.g., in approximately real-time), and after use by the front-end application, any ephemeral data and/or temporary cache is cleared.

One or more embodiments can include leveraging one or more data security and/or data privacy protocols and/or principles, ensuring compliance with one or more data handling policies. Also, such an embodiment can include implementing encryption techniques, wherein even though the data is synthetic, communication between microservices and the front-end can be secured using transport layer security (TLS) and/or hypertext protocol secure (HTTPS). Further, in at least one embodiment, access to the framework’s API(s) can be restricted to authorized services and/or users by use of one or more authentication techniques.

Additionally, one or more embodiments can include implementing caching strategies in connection with, for example, caching repeated request patterns for quick data generation, maintaining designated time to live (TTL) constraints for generated data to limit and/or avoid data staleness. Also, such an embodiment can include utilizing asynchronous handling techniques, which can include non-blocking input-output, such that the artificial intelligence-based data generation process does not hinder application performance. Further, such an embodiment can include enabling horizontal scaling by leveraging containerization and orchestration (e.g., Kubernetes) to handle spikes in demonstration requests.

Also, as detailed herein, one or more embodiments include utilizing and/or implementing one or more generative artificial intelligence techniques. By way of example, such an embodiment can include implementing one or more domain-specific models, which can include domain-trained models and/or fine-tuned large language models (LLM) corresponding to respective specialized fields (e.g., financial transactions, healthcare, etc.). Additionally or alternatively, such an embodiment can include implementing one or more open source models and/or one or more proprietary models (e.g., one or more GPT-based models, one or more bidirectional encoder representations from transformers (BERT) derivatives, one or more custom models, etc.) selected based at least in part on the enterprise’s compliance and/or performance needs. Further, at least one embodiment can include retraining any implemented models with anonymized domain data patterns (without real data).

One or more embodiments can also include implementing logging techniques only, e.g., for one or more performance metrics, and not for any generated synthetic data or real data. Also, such an embodiment can include implementing one or more monitoring tools such as, for example, using distributed tracing to track request flows, measure latencies, etc. Additionally, at least one embodiment includes performing anomaly detection, which can include monitoring data requests for one or more unusual request patterns that might indicate malicious intent and/or misuse.

As also detailed herein, one or more embodiments include increasing regulatory compliance and operational efficiency. For example, such an embodiment can include reducing reliance on large masked datasets that often become outdated and/or cumbersome. Additionally, the modular architecture of at least one embodiment can be scaled and integrated across various systems, applications and/or data sources. By way of illustration, such an embodiment can include integration with software demonstration applications, one or more training systems (e.g., training users on systems without exposing live production data), and/or one or more testing systems (e.g., generating and implementing automated tests across multiple contexts while preserving data sensitivity).

At least one embodiment also includes incorporating adaptive data obfuscation techniques with domain-aware artificial intelligence models. In such an embodiment, the middleware incorporates one or more context-aware generative models that intelligently apply one or more domain-specific transformations and/or one or more configurable masking rules. This ensures that the generated synthetic data not only mimics real-world structures (e.g., financial transactions, healthcare records, e-commerce interactions, etc.), but also adheres to one or more regulatory and/or enterprise constraints, enhancing realism without exposing sensitive information.

Further, as detailed herein, one or more embodiments include integration across multiple data ecosystems. For example, as a stateless, API-driven middleware, the framework detailed herein can integrate with one or more data structures, one or more microservices, and/or one or more API-driven applications using protocols such as, e.g., REST, GraphQL, message queues, etc. Also, low-latency processing and modular architecture associated with the framework enable scalable deployment across multiple enterprise environments, ensuring frictionless adoption without modifying existing infrastructure.

As detailed herein, synthetic data generation techniques can create new instances of data with unique attributes and/or circumstances that may not be present in the original dataset. As also detailed herein, one or more embodiments include generating synthetic data using one or more CTGANs, which can, for example, process complex column distributions and address challenges related to imbalanced training data. Mode-specific normalization techniques associated with CTGANs can enhance the ability to generate high-fidelity tabular data, making CTGANs particularly valuable in privacy-sensitive contexts and/or use cases, wherein data security and accuracy are critical. More particularly, such mode-specific normalization techniques can include transforming continuous values into bounded vector representations optimized for neural network processing. Additionally, in implementing CTGANs, the use of conditional generators and training-by-sampling strategies can efficiently address imbalanced training data, a common issue in real-world datasets.

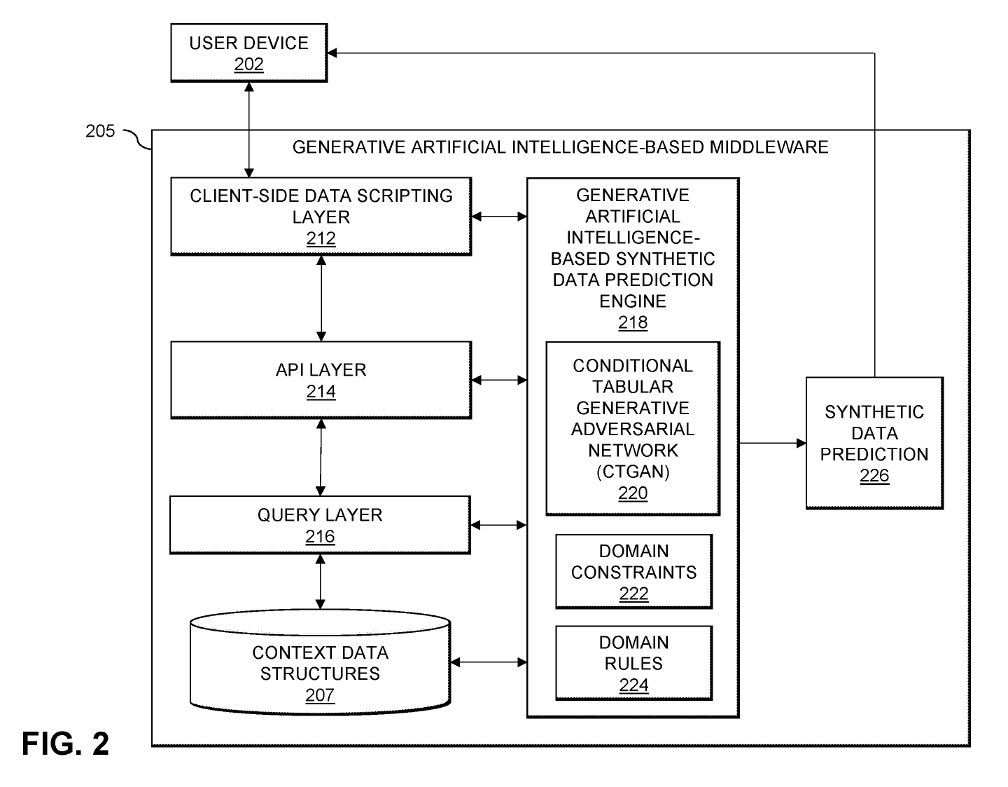

FIG. 2 shows an example system architecture and workflow in an illustrative embodiment. By way of illustration, FIG. 2 depicts user device 202 and generative artificial intelligence-based middleware 205, which includes client-side data scripting layer 212, API layer 214, query layer 216, context data structures 207, and generative artificial intelligence-based synthetic data prediction engine 218. Further, as depicted in FIG. 2, generative artificial intelligence-based synthetic data prediction engine 218, using CTGAN 220 in conjunction with one or more domain constraints 222 and one or more domain rules 224, as well as inputs from client-side data scripting layer 212, API layer 214, query layer 216, context data structures 207, generates a synthetic data prediction 226, which is ultimately output to user device 202.

In connection with the example embodiment depicted in FIG. 2, context data structures 207 store raw and/or structured data across various contexts (e.g., user data, transaction logs, policy information, etc.), and such data is stored with all applicable data policies (e.g., access control, compliance, retention, etc.), which helps to ensures that data is persisted and governed properly. Also, query layer 216 acts as a data access engine that fetches data from multiple sources and/or contexts, and can support context-aware querying, retrieving relevant data segments as needed. Accordingly, and as depicted in FIG. 2, query layer 216 interfaces between stored data (such as, for example, maintained in context data structures 207) and one or more higher application logic layers (accessed and/or derived via API layer 214).

Also, API layer 214 applies business logic to data fetched by the query layer 216, and can also transform data based at least in part on one or more rules, calculations, and/or domain-specific logic. For example, API layer 214 can convert raw data into enterprise-ready information for client consumption and/or synthetic generation. Additionally, client-side data scripting layer 212 transforms and/or formats data according to one or more specific client and/or frontend requirements. Accordingly, client-side data scripting layer 212 can handle presentation logic, field formatting, and client-specific data adaptations, which helps ensure that data is ready to be rendered cleanly and understandably in a user interface.

As further detailed herein, CTGAN 220 can model mixed data types (e.g., categorical data and continuous data) as well as integrate the one or more domain constraints 222 to reflect and/or implement one or more domain rules 224. By way of example, generative artificial intelligence-based middleware 205 can be configured to ingest data in JSON format and/or via CSV file uploads. Further, in at least one embodiment, generative artificial intelligence-based middleware 205 can also process and/or specify domain information, which can trigger domain constraints 222 (e.g., price ≥ 0) and/or transformations (e.g., date conversions). Also, in such an embodiment, generative artificial intelligence-based synthetic data prediction engine 218 can perform personally identifiable information (PII) overrides using, for example, a Faker library (e.g., generating realistic names and/or emails for use in place of real/actual names and/or emails). Additionally, in one or more embodiments, CTGAN 220 operates in memory, such that no disk storage is performed, thereby satisfying one or more privacy and/or ephemeral usage requirements.

With respect to domain knowledge, while CTGAN 220 can learn distributions from raw data, real-world datasets often have enterprise rules and/or logical constraints that CTGAN 220 cannot automatically infer. For example, in an e-commerce context, such rules and/or constraints can include: a price should never be negative, a discount should not exceed price, etc. By encoding domain knowledge as constraints and/or transformations, CTGAN 220 can produce more accurate and/or realistic synthetic data.

Accordingly, in at least one embodiment, a domain parameter (e.g., domain = “e-commerce”) can act as a switch to load one or more relevant constraints, apply one or more domain-specific transformations, and/or post-process or validate outputs. In connection with post-processing or validating outputs, consider an example scenario wherein if the domain is finance, such an embodiment can include ensuring no invalid credit scores are used in the synthetic data. Additionally, one or more embodiments can include extending such techniques by implementing a dictionary and/or code block that maps each domain to one or more associated rules, constraints, transformations, and/or validations.

In accordance with one or more embodiments, an example workflow and/or application flow can include the following. An application (an e-commerce application, a clinical application, etc., also represented by web applications 110 in FIG. 1) sends a POST request, with data and domain information, to generative artificial intelligence-based middleware to generate synthetic data. The generative artificial intelligence-based middleware accepts the data via at least one endpoint (e.g., JSON, CSV, etc.), and parses and/or preprocesses the data in memory. Further, the generative artificial intelligence-based middleware processes the parsed and/or preprocessed data to identify at least one domain associated with the data and/or the request, and to load one or more domain rules, constraints and/or transformations associated with the at least one identified domain.

Also, the generative artificial intelligence-based middleware used at least a portion of the one or more domain rules, constraints and/or transformations to train at least one CTGAN, and subsequently use the at least one trained CTGAN to generate synthetic data in memory. Additionally, in one or more embodiments, the generative artificial intelligence-based middleware can override or replace PII data (e.g., using a Faker library), and return the ultimate synthetic data to the requesting application (e.g., via one or more user devices) in a given format (e.g., JSON).

By way merely of example, in executing such an example application flow, the generative artificial intelligence-based middleware can utilize elements such as FastAPI and Uvicorn for an API service, an SDV which contains at least one CTGAN synthesizer and one or more constraints, at least one Faker library for generating realistic PII replacement data (if needed), Pandas for in-memory dataframe operations, and Pydantic for data validation and request modeling in FastAPI.

By way of further example using FastAPI, such an embodiment can include defining one or more Pydantic models to structure incoming requests. For instance, a SyntheticRequest can be defined to include a list of row dictionaries (e.g., when using JSON), the number of synthetic samples to generate, whether to replace any PII columns with Faker data, and a string specifying which domain rules to apply.

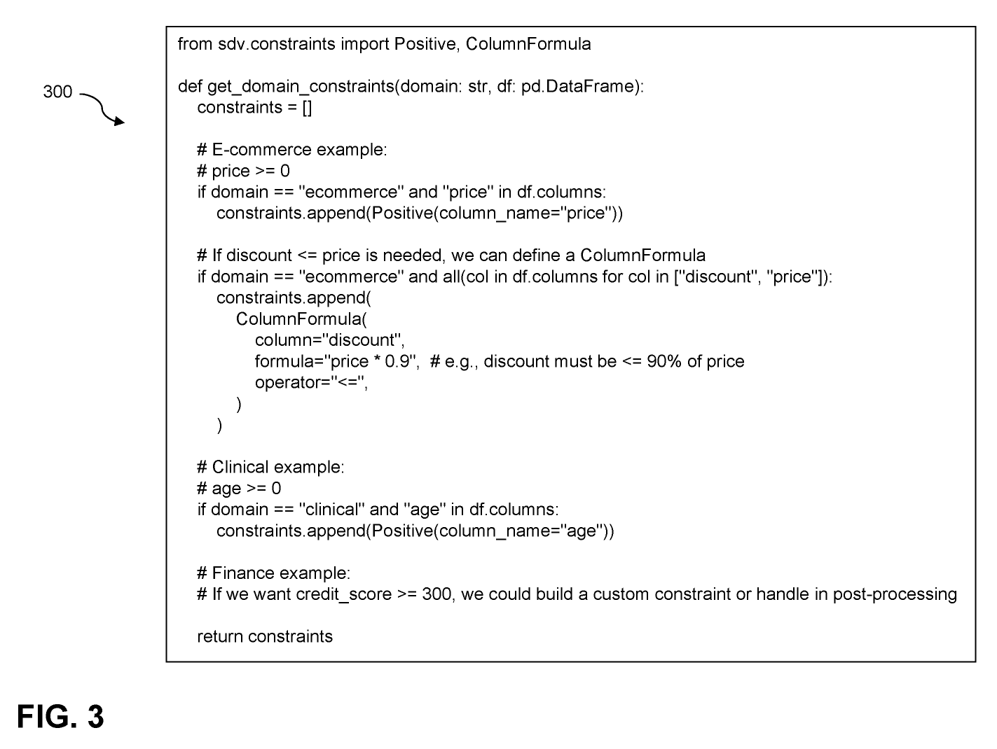

FIG. 3 shows example pseudocode for determining constraints in an illustrative embodiment. In this embodiment, example pseudocode 300 is executed by or under the control of at least one processing system and/or device. For example, the example pseudocode 300 may be viewed as comprising a portion of a software implementation of at least part of generative artificial intelligence-based middleware 105 of the FIG. 1 embodiment.

The example pseudocode 300 illustrates determining and/or obtaining domain knowledge, including one or more constraints and one or more transformations, by creating at least one internal mapping from domain information to constraints and/or transformations.

It is to be appreciated that this particular example pseudocode shows just one example implementation of determining constraints, and alternative implementations can be used in other embodiments.

The code depicted in FIG. 3 can be incorporated in one or more embodiments which include generating synthetic data in connection with JSON formatted data and/or CSV formatted data. For example, in connection with generating synthetic data from at least one JSON input, such an embodiment can include obtaining and/or accepting a JSON body matching synthetic request, convert data associated with the request to a Pandas dataframe, determining one or more constraints based at least in part on domain information, training a CTGAN-based synthesizer in memory, generating synthetic data using the trained CTGAN-based synthesizer, optionally overriding one or more PII columns, and returning the synthetic data in JSON format.

Alternatively, in connection with generating synthetic data from at least one CSV file, such an embodiment can include obtaining and/or accepting a CSV file upload, reading the CSV file into a dataframe, applying one or more of the following domain-based constraints, training at least one CTGAN, generating synthetic data using the trained CTGAN, and returning the synthetic data.

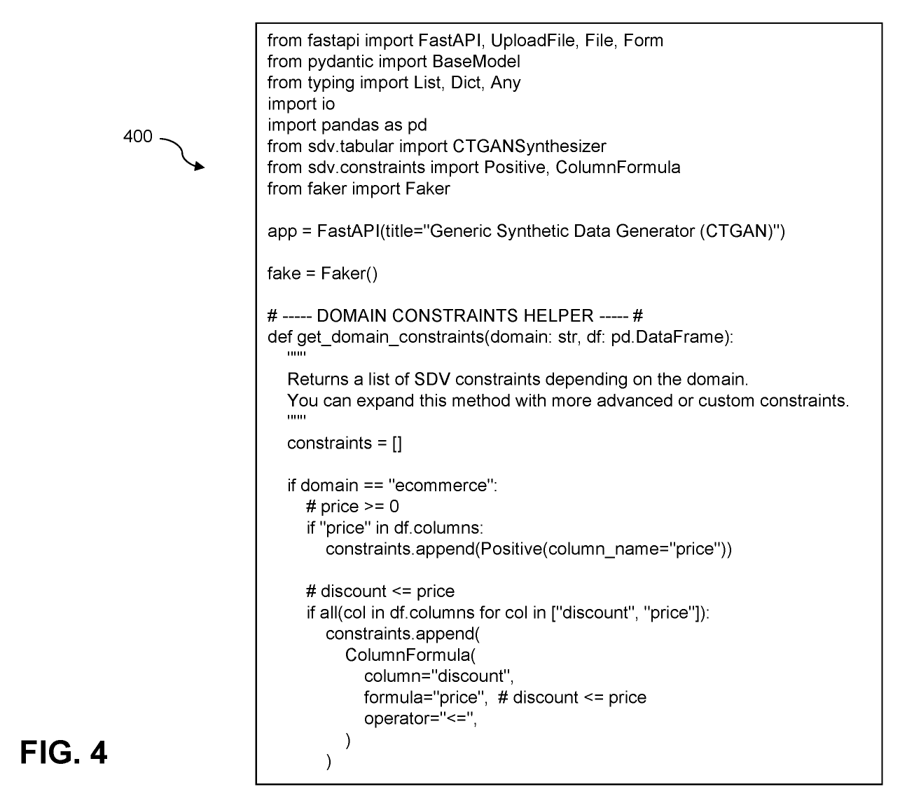

FIG. 4 shows example pseudocode for determining constraints in an illustrative embodiment. In this embodiment, example pseudocode 400 is executed by or under the control of at least one processing system and/or device. For example, the example pseudocode 400 may be viewed as comprising a portion of a software implementation of at least part of generative artificial intelligence-based middleware 105 of the FIG. 1 embodiment.

The example pseudocode 400 illustrates providing foundational context and/or groundwork for a system, in an e-commerce setting, that would accept a dataset file from a user via an API, apply domain-specific constraints, use CTGAN to generate synthetic tabular data, and return the synthetic data, which adheres to realistic enterprise logic.

It is to be appreciated that this particular example pseudocode shows just one example implementation of determining constraints, and alternative implementations can be used in other embodiments.

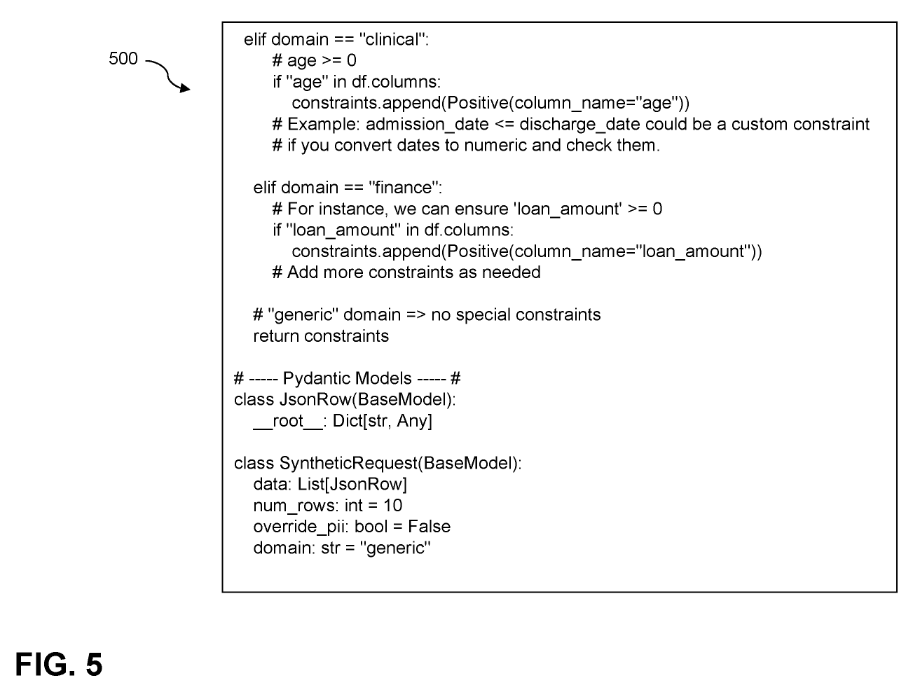

FIG. 5 shows example pseudocode for determining constraints in an illustrative embodiment. In this embodiment, example pseudocode 500 is executed by or under the control of at least one processing system and/or device. For example, the example pseudocode 500 may be viewed as comprising a portion of a software implementation of at least part of generative artificial intelligence-based middleware 105 of the FIG. 1 embodiment.

The example pseudocode 500 illustrates similar actions to example pseudocode 400 in FIG. 4, but in connection with clinical and finance data through the use of one or more domain rules.

It is to be appreciated that this particular example pseudocode shows just one example implementation of determining constraints, and alternative implementations can be used in other embodiments.

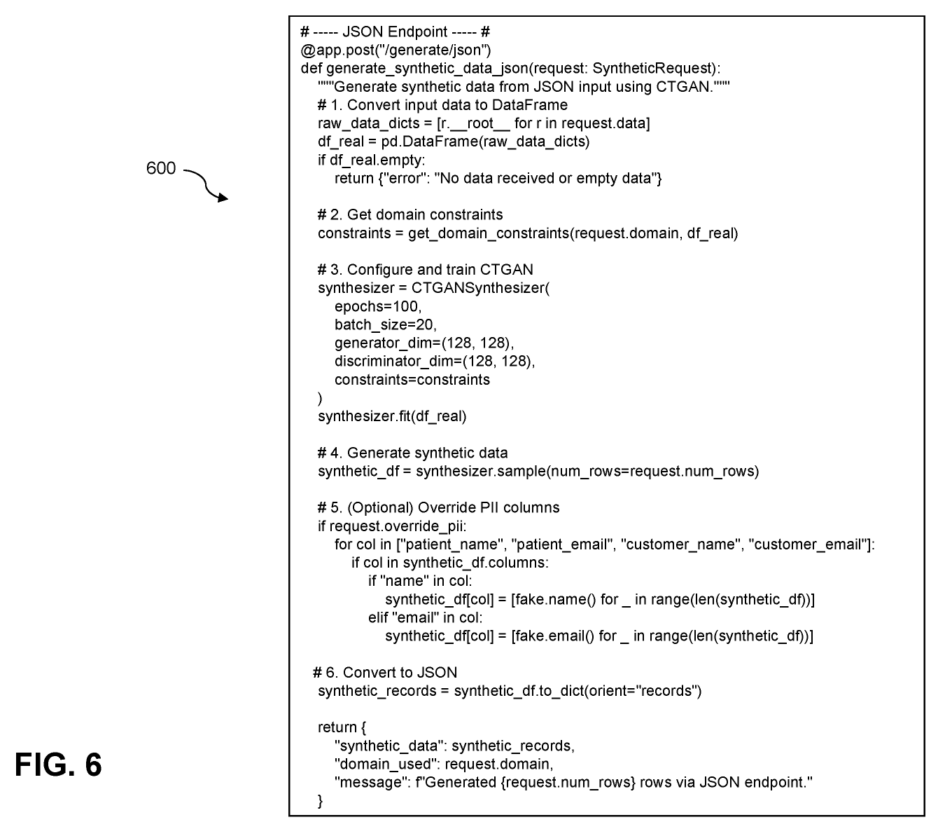

FIG. 6 shows example pseudocode for generating synthetic data from JSON input using at least one CTGAN in an illustrative embodiment. In this embodiment, example pseudocode 600 is executed by or under the control of at least one processing system and/or device. For example, the example pseudocode 600 may be viewed as comprising a portion of a software implementation of at least part of generative artificial intelligence-based middleware 105 of the FIG. 1 embodiment.

The example pseudocode 600 illustrates converting input data to a dataframe, determining and/or obtaining domain constraints, configuring and/or training the at least one CTGAN, generating synthetic data, optionally overriding one or more PII columns, and converting the synthetic data to JSON.

It is to be appreciated that this particular example pseudocode shows just one example implementation of generating synthetic data from JSON input using CTGAN, and alternative implementations can be used in other embodiments.

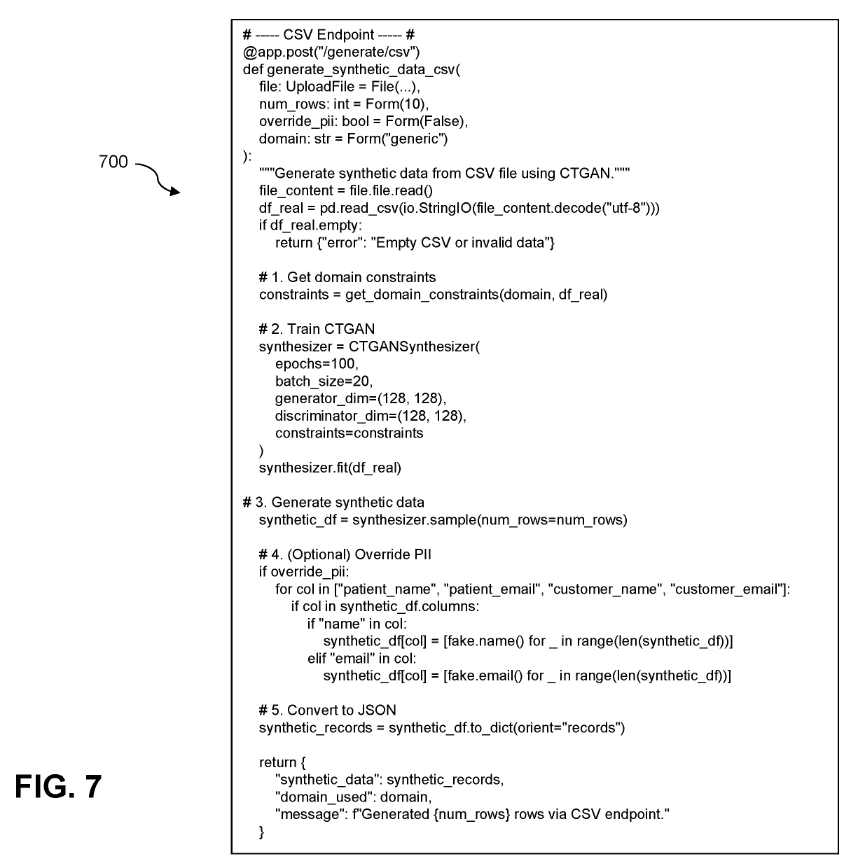

FIG. 7 shows example pseudocode for generating synthetic data from a CSV file using at least one CTGAN in an illustrative embodiment. In this embodiment, example pseudocode 700 is executed by or under the control of at least one processing system and/or device. For example, the example pseudocode 700 may be viewed as comprising a portion of a software implementation of at least part of generative artificial intelligence-based middleware 105 of the FIG. 1 embodiment.

The example pseudocode 700 illustrates determining and/or obtaining domain constraints, training the at least one CTGAN, generating synthetic data, optionally overriding PII data, and converting the synthetic data to JSON. Additionally or alternatively, in one or more embodiments, the synthetic data can be provided as a CSV file as well as JSON data through at least one API.

It is to be appreciated that this particular example pseudocode shows just one example implementation of generating synthetic data from a CSV file using at least one CTGAN, and alternative implementations can be used in other embodiments.

As detailed herein, one or more embodiments include leveraging one or more domain parameters. For example, one or more domain parameters can be provided by the user as part of the synthetic data request. Based at least in part on such domain parameters, at least one embodiment can include creating a list of one or more constraints that reflect one or more domain rules (e.g., typical domain rules). Such an embodiment can further include passing the one or more constraints to at least one CTGAN, such that the at least one CTGAN honors those rules during synthetic data generation. One or more embodiments can also include leveraging additional domain logic, for example, by adding post-processing, transformations (e.g., dates, etc.), and/or one or more custom functions as part of the domain parameter determinations.

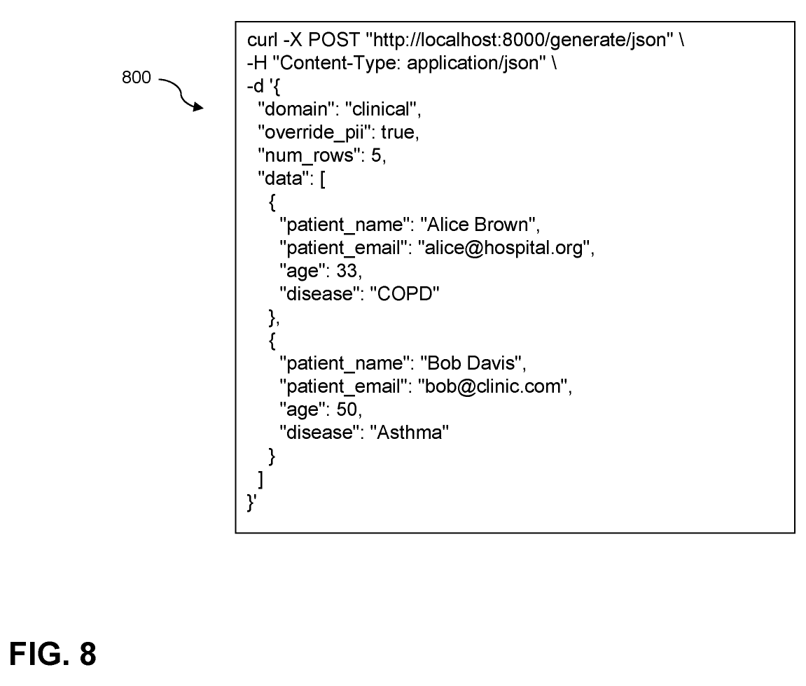

FIG. 8 shows example pseudocode for implementing at least one example usage endpoint in an illustrative embodiment. In this embodiment, example pseudocode 800 is executed by or under the control of at least one processing system and/or device. For example, the example pseudocode 800 may be viewed as comprising a portion of a software implementation of at least part of generative artificial intelligence-based middleware 105 of the FIG. 1 embodiment.

The example pseudocode 800 illustrates an API end point accepting real data as a JSON request and generating synthetic data corresponding thereto. More particularly, in example pseudocode 800, “domain”: “clinical” informs the server of the type of data domain (e.g., triggering clinical-specific rules and/or constraints), while “override_pii”: true requests the system to obfuscate PII such as names and emails. Additionally, in example pseudocode 800, “num_rows”: 5 requests the API to generate five rows of synthetic data, while “data” identifies the dataset or sample that the synthetic generator will use as a statistical and structural reference.

It is to be appreciated that this particular example pseudocode shows just one example implementation of at least one example usage endpoint, and alternative implementations can be used in other embodiments.

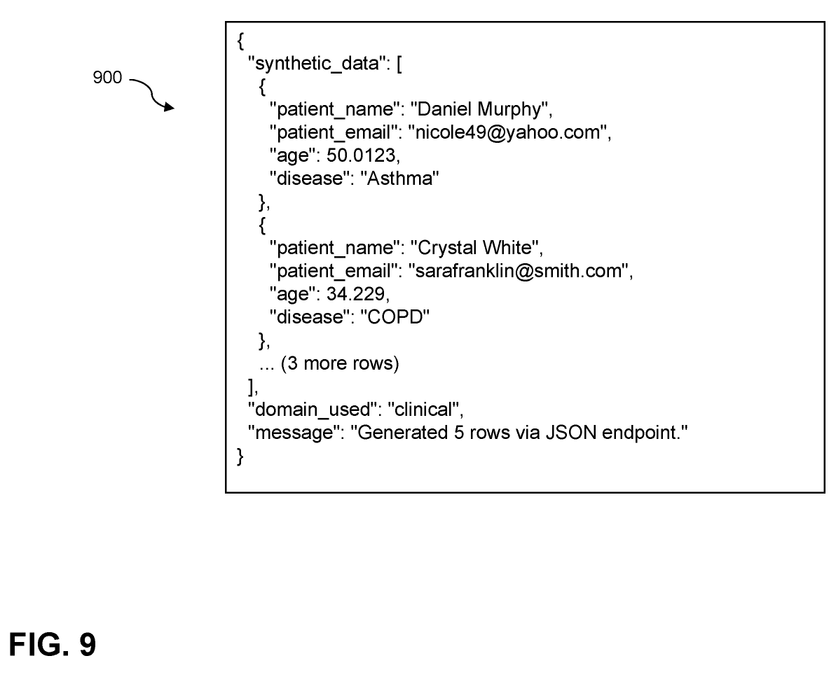

FIG. 9 shows example pseudocode for implementing a synthetic data response in an illustrative embodiment. In this embodiment, example pseudocode 900 is executed by or under the control of at least one processing system and/or device. For example, the example pseudocode 900 may be viewed as comprising a portion of a software implementation of at least part of generative artificial intelligence-based middleware 105 of the FIG. 1 embodiment.

The example pseudocode 900 illustrates recognizing domain parameters of “clinical” and “enforced age ≥ 0” in example pseudocode 800, and also replacing particular PII columns (patient_name, patient_email) with alternate outputs.

It is to be appreciated that this particular example pseudocode shows just one example implementation of a synthetic data response, and alternative implementations can be used in other embodiments.

As detailed above and further herein, one or more embodiments can include expanding code to handle one or more advanced domain rules. By way merely of example, such advanced domain rules might describe minimum and maximum prices for one or more products, or might describe at least one category-product relationship, wherein if certain product IDs are to only appear with certain categories, a custom constraint can be used. Further, such advanced domain rules might require converting dates to numeric values of a given format (e.g., timestamps, days since a given year, etc.). Accordingly, at least one embodiment can include handling multiple domains through at least one domain parameter that loads one or more relevant constraints and/or transformations.

Further, one or more embodiments include training a synthetic model (e.g., a CTGAN) in memory, returning results to a corresponding request without necessitating the use of disk input/output (I/O) operations. Additionally, as detailed herein, one or more embodiments can include overriding data values in designated PII columns with alternate data to maintain realism without risking confidentiality.

By way merely of illustration, consider the following example use cases in accordance with one or more embodiments. For instance, consider an example use case wherein an organization wants to share customer transaction data but must comply with strict privacy regulations. In such an example use case, at least one embodiment can include using a CTGAN to generate synthetic customer transaction records that maintain one or more statistical properties, correlations, and/or fraud patterns (as the real data) without exposing real user identities. For example, given a dataset with attributes such as customer ID, age, transaction amount, and transaction type, the CTGAN can generate synthetic customer information with realistic spending patterns, while ensuring sensitive personal data remains confidential.

Also, in another example, consider a use case wherein a manufacturing company wants to analyze defective parts but has limited historical data due to rare defects. In such an example use case, at least one embodiment can include using a CTGAN to generate synthetic records of parts with one or more realistic features. More particularly, a dataset containing attributes such as part ID, material type, temperature resistance, and failure rate can be expanded using synthetic data, allowing for better predictive maintenance models and quality control.

Additionally, in yet another example, consider a use case wherein a cybersecurity firm is developing an anomaly detection system for network logs, but lacks diverse attack pattern data. In such an example use case, at least one embodiment can include using a CTGAN to generate synthetic network activity logs, including normal and anomalous behaviors, ensuring robust training data without compromising real network security logs. More particularly, a log dataset with event timestamps, user IDs, IP addresses, and access actions can be enriched with synthetic logs to simulate rare but critical security breaches such as, e.g., unauthorized access, insider threats, etc.

FIG. 10 is a flow diagram of a process for implementing generative artificial intelligence-based middleware for data synthesis in an illustrative embodiment. It is to be understood that this particular process is only an example, and additional or alternative processes can be carried out in other embodiments.

In this embodiment, the process includes steps 1000 through 1006. These steps are assumed to be performed by the generative artificial intelligence-based middleware 105 utilizing elements 112, 114, 116 and 118.

Step 1000 includes obtaining at least one request for data related to execution of at least one application. In at least one embodiment, obtaining at least one request for data includes intercepting the at least one request for data in between the at least one application and one or more data structures. Additionally or alternatively, obtaining at least one request for data can include obtaining at least one request for data in conjunction with at least one demonstration of application functionality associated with the execution of the at least one application.

Step 1002 includes determining at least one of one or more required fields and one or more domain-specific constraints associated with the at least one request for data. In one or more embodiments, determining at least one of one or more required fields and one or more domain-specific constraints associated with the at least one request for data includes identifying at least one domain attributed to the at least one request for data and obtaining the one or more domain-specific constraints in response to identifying the at least one domain attributed to the at least one request for data. Additionally or alternatively, determining at least one of one or more required fields and one or more domain-specific constraints associated with the at least one request for data can include determining a data schema corresponding to the at least one request for data.

Step 1004 includes generating, using one or more generative artificial intelligence techniques, synthetic data responsive to the at least one request and in accordance with one or more data obfuscation rules and the at least one of one or more required fields and one or more domain-specific constraints. In at least one embodiment, generating synthetic data includes processing the at least one request, the one or more data obfuscation rules, and the at least one of one or more required fields and one or more domain-specific constraints using at least one CTGAN. Additionally or alternatively, generating synthetic data can include generating the synthetic data and modifying at least a portion of the generated synthetic data associated with personally identifiable information in accordance with the one or more data obfuscation rules. Further, in at least one embodiment, generating synthetic data includes generating, using the one or more generative artificial intelligence techniques, stateless synthetic data responsive to the at least one request and in accordance with the one or more data obfuscation rules and the at least one of one or more required fields and one or more domain-specific constraints.

Step 1006 includes performing one or more automated actions using at least a portion of the synthetic data. In one or more embodiments, performing one or more automated actions includes automatically transmitting the at least a portion of the synthetic data to the at least one application in response to the at least one request. In such an embodiment, performing one or more automated actions can also include deleting, from sources associated with the at least one generative artificial intelligence-based middleware, one or more of ephemeral data corresponding to the generated synthetic data and temporary cache corresponding to the generated synthetic data subsequent to automatically transmitting the at least a portion of the synthetic data to the at least one application. Additionally or alternatively, performing one or more automated actions can include automatically training at least a portion of the one or more generative artificial intelligence techniques based at least in part on feedback to the at least a portion of the synthetic data.

Accordingly, the particular processing operations and other functionality described in conjunction with the flow diagram of FIG. 10 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate synthetic data for use in one or more particular contexts through the implementation and use of generative artificial intelligence-based middleware. These and other embodiments can effectively overcome problems associated with data breaches, regulatory violations, and reputational damage.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

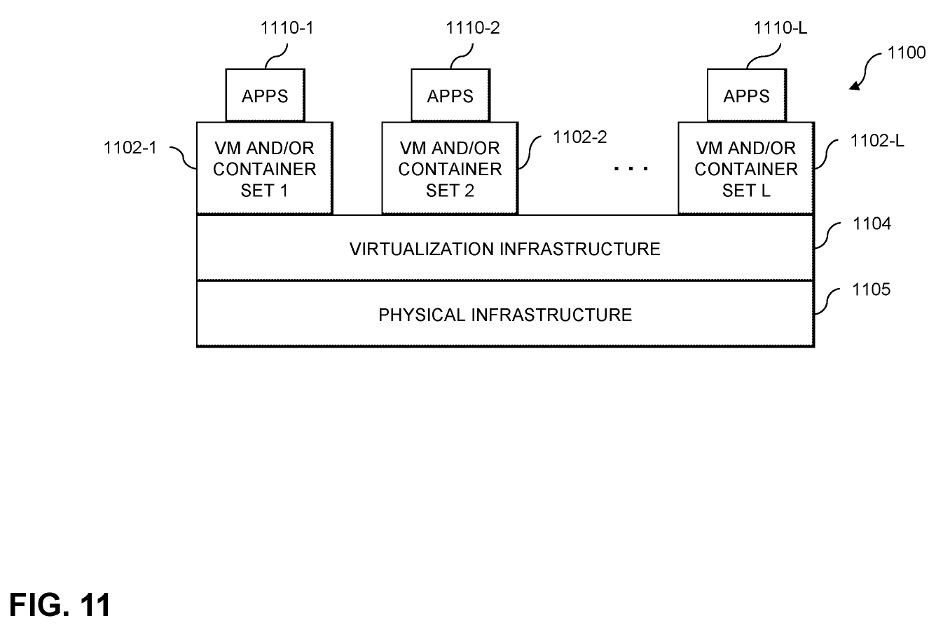

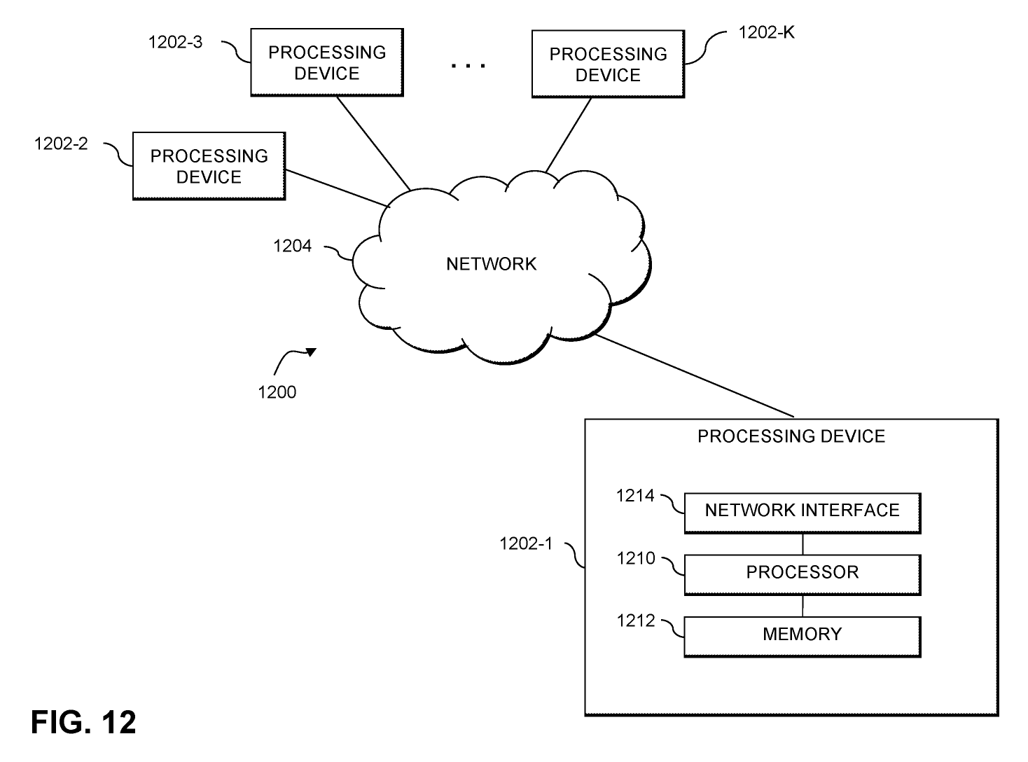

Illustrative embodiments of processing platforms will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that are utilized to implement at least a portion of the information processing system 100. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 comprise respective VMs, respective sets of one or more containers, or respective sets of one or more containers running in VMs. In some implementations of the FIG. 11 embodiment, the VMs/container sets 1102 comprise respective VMs implemented using virtualization infrastructure 1104 that comprises at least one hypervisor.

A hypervisor platform may be used to implement a hypervisor within the virtualization infrastructure 1104, wherein the hypervisor platform has an associated virtual infrastructure management system. The underlying physical machines comprise one or more information processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1202-1 in the processing platform 1200 comprises a processor 1210 coupled to a memory 1212.

The processor 1210 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 1212 comprises RAM, ROM or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
obtaining at least one request for data related to execution of at least one application;
determining at least one of one or more required fields and one or more domain-specific constraints associated with the at least one request for data;
generating, using one or more generative artificial intelligence techniques, synthetic data responsive to the at least one request and in accordance with one or more data obfuscation rules and the at least one of one or more required fields and one or more domain-specific constraints; and
performing one or more automated actions using at least a portion of the synthetic data;
wherein the method is performed by at least one generative artificial intelligence-based middleware.

2. The computer-implemented method of claim 1, wherein determining at least one of one or more required fields and one or more domain-specific constraints associated with the at least one request for data comprises identifying at least one domain attributed to the at least one request for data and obtaining the one or more domain-specific constraints in response to identifying the at least one domain attributed to the at least one request for data.

3. The computer-implemented method of claim 1, wherein generating synthetic data comprises processing the at least one request, the one or more data obfuscation rules, and the at least one of one or more required fields and one or more domain-specific constraints using at least one conditional tabular generative adversarial network (CTGAN).

4. The computer-implemented method of claim 1, wherein generating synthetic data comprises generating the synthetic data and modifying at least a portion of the generated synthetic data associated with personally identifiable information in accordance with the one or more data obfuscation rules.

5. The computer-implemented method of claim 1, wherein performing one or more automated actions comprises automatically transmitting the at least a portion of the synthetic data to the at least one application in response to the at least one request.

6. The computer-implemented method of claim 5, wherein performing one or more automated actions comprises deleting, from sources associated with the at least one generative artificial intelligence-based middleware, one or more of ephemeral data corresponding to the generated synthetic data and temporary cache corresponding to the generated synthetic data subsequent to automatically transmitting the at least a portion of the synthetic data to the at least one application.

7. The computer-implemented method of claim 1, wherein obtaining at least one request for data comprises intercepting the at least one request for data in between the at least one application and one or more data structures.

8. The computer-implemented method of claim 1, wherein determining at least one of one or more required fields and one or more domain-specific constraints associated with the at least one request for data comprises determining a data schema corresponding to the at least one request for data.

9. The computer-implemented method of claim 1, wherein obtaining at least one request for data comprises obtaining at least one request for data in conjunction with at least one demonstration of application functionality associated with the execution of the at least one application.

10. The computer-implemented method of claim 1, wherein performing one or more automated actions comprises automatically training at least a portion of the one or more generative artificial intelligence techniques based at least in part on feedback to the at least a portion of the synthetic data.

11. The computer-implemented method of claim 1, wherein generating synthetic data comprises generating, using the one or more generative artificial intelligence techniques, stateless synthetic data responsive to the at least one request and in accordance with the one or more data obfuscation rules and the at least one of one or more required fields and one or more domain-specific constraints.

12. A non-transitory processor-readable storage medium having stored therein program code of one or more software programs, wherein the program code when executed by at least one processing device causes the at least one processing device:
to obtain at least one request for data related to execution of at least one application;
to determine at least one of one or more required fields and one or more domain-specific constraints associated with the at least one request for data;
to generate, using one or more generative artificial intelligence techniques, synthetic data responsive to the at least one request and in accordance with one or more data obfuscation rules and the at least one of one or more required fields and one or more domain-specific constraints; and
to perform one or more automated actions using at least a portion of the synthetic data.

13. The non-transitory processor-readable storage medium of claim 12, wherein determining at least one of one or more required fields and one or more domain-specific constraints associated with the at least one request for data comprises identifying at least one domain attributed to the at least one request for data and obtaining the one or more domain-specific constraints in response to identifying the at least one domain attributed to the at least one request for data.

14. The non-transitory processor-readable storage medium of claim 12, wherein generating synthetic data comprises processing the at least one request, the one or more data obfuscation rules, and the at least one of one or more required fields and one or more domain-specific constraints using at least one conditional tabular generative adversarial network (CTGAN).

15. The non-transitory processor-readable storage medium of claim 12, wherein generating synthetic data comprises generating the synthetic data and modifying at least a portion of the generated synthetic data associated with personally identifiable information in accordance with the one or more data obfuscation rules.

16. An apparatus comprising:
at least one processing device comprising a processor coupled to a memory;
the at least one processing device being configured:
to obtain at least one request for data related to execution of at least one application;
to determine at least one of one or more required fields and one or more domain-specific constraints associated with the at least one request for data;
to generate, using one or more generative artificial intelligence techniques, synthetic data responsive to the at least one request and in accordance with one or more data obfuscation rules and the at least one of one or more required fields and one or more domain-specific constraints; and
to perform one or more automated actions using at least a portion of the synthetic data.

17. The apparatus of claim 16, wherein determining at least one of one or more required fields and one or more domain-specific constraints associated with the at least one request for data comprises identifying at least one domain attributed to the at least one request for data and obtaining the one or more domain-specific constraints in response to identifying the at least one domain attributed to the at least one request for data.

18. The apparatus of claim 16, wherein generating synthetic data comprises processing the at least one request, the one or more data obfuscation rules, and the at least one of one or more required fields and one or more domain-specific constraints using at least one conditional tabular generative adversarial network (CTGAN).

19. The apparatus of claim 16, wherein generating synthetic data comprises generating the synthetic data and modifying at least a portion of the generated synthetic data associated with personally identifiable information in accordance with the one or more data obfuscation rules.

20. The apparatus of claim 16, wherein performing one or more automated actions comprises automatically transmitting the at least a portion of the synthetic data to the at least one application in response to the at least one request.
